(19) United States
(12) Patent Application Publication
(10) Pub. No.: US 2014/0140578 A1
(43) Pub. Date: May 22, 2014

(54) PARKING ENFORCEMENT SYSTEM AND METHOD OF PARKING ENFORCEMENT

(71) Applicant: APARC SYSTEMS INC., Vancouver (CA)

(72) Inventors: Robert Ziola, Vancouver (CA); Robert Suranyi, Vancouver (CA)

(73) Assignee: APARC Systems Inc., Vancouver (CA)

(21) Appl. No.: 13/756,466

(22) Filed: Jan. 31, 2013

Related U.S. Application Data
(60) Provisional application No. 61/729,348, filed on Nov. 22, 2012.

(51) Int. Cl. G06K 9/32; G06Q 50/30

(52) U.S. Cl. CPC G06K 9/3258; G06Q 50/30
USPC 382/105

(57) ABSTRACT

A parking enforcement system comprises a camera for capturing a license plate image and software for analyzing the license plate image to generate a read license plate number. The read license plate number is cross-referenced with a list of known license plate numbers to determine if the read license plate number is associated with a payment event. A citation against the read licence plate number if the read license plate is not associated with a payment event.

### CROSS-REFERENCE TO RELATED APPLICATION

This application claims the benefit of provisional application 61/729,348 filed in the United States Patent and Trademark Office on Nov. 22, 2012, the disclosure of which is incorporated herein by reference and priority to which is claimed.

### BACKGROUND OF THE INVENTION

1. Field of the Invention

The present invention relates to a parking enforcement system and, in particular, to a parking enforcement system in which a read license plate number is cross-referenced against a list of known license plate numbers to determine if a user has paid for parking.

2. Description of the Related Art

It is known from U.S. Pat. No. 6,823,317 to Ouimet et al. to use a wireless network, covering a large local geographic area, to link a large number of payment terminals provided in the same area. Each payment terminal is located near a plurality of parking spaces either at the curbside or in municipal lots. Parking data is gathered from motorists at the payment terminals. The parking data includes vehicle identification data or parking space identification data. The parking data is sent from the payment terminals to the wireless network in response to payment made at the payment terminals. Portable terminals are provided for use by parking wardens inspecting the parking spaces of the local geographic area. The wireless network is used to transmit the parking data substantially upon receipt from the payment terminals to the portable terminals in the local geographic area.

### SUMMARY OF THE INVENTION

There is provided a parking enforcement system comprising a camera and a processor. The camera captures a license plate image at a parking location to record a parking event. The server includes a database which stores a list of known license plate numbers that are each associated with a payment event. The camera and the server are in communication via a network. License plate recognition software is used to analyze the license plate image to generate a read license plate number. The read license plate number is cross-referenced with the list of known license plate numbers to determine if the read license plate number is associated with a payment event. The license plate recognition software may use fuzzy logic to generate the read license plate number.

The parking enforcement system may further include a processor in communication with the server to allow a user to communicate with the server. There may be a sensor to sense and validate the parking event at the parking location. The sensor may one of a plurality of sensors arranged in a mesh network. There may be a hub that receives a signal from the sensor when the sensor senses the parking event. A database on the server may store parking information and payment information received from the parking location. Remote terminals may be in communication with server and the parking information or the payment or both may be selectively sent from the server to the remote terminals. The remote terminals may be in communication with the processor via a general packet radio service.

There is also provided a method of parking enforcement, the method comprises the steps of:
a) capturing a license plate image with a camera at a parking location to record a parking event;
b) analyzing the license plate image with license plate recognition software to generate a read license plate number;
c) associating the read license plate number with the parking event;
d) cross-referencing the read license plate number with a list of known license plates that are each associated with a payment event to determine if the read license plate number is associated with a said payment event.

Analyzing the license plate image with the license plate recognition software may include analyzing the license plate image using fuzzy logic. Information may be selectively communicated to a remote terminal when the read license plate number is both associated with the parking event and not associated with a said payment event. Information may be communicated to the remote terminal via a general packet radio service. A sensor may be used to sense a vehicle in the parking location and thereby validate the parking event. Information may only be communicated to the remote terminal if the parking event has been validated. A citation may be issued against the read licence plate number if the read license plate is not associated with a payment event. Information may be selectively communicated to the remote terminal if the license plate recognition software cannot generate a said read license plate number.

### BRIEF DESCRIPTIONS OF DRAWINGS

The invention will be more readily understood from the following description of the embodiments thereof given, by way of example only, with reference to the accompanying drawings, in which:

FIG. 1 is a schematic of an improved parking enforcement system;

FIG. 2 is a schematic of a parking location of the parking enforcement system of FIG. 1;

FIG. 3 is a first flow chart showing the logic of the parking enforcement system of FIG. 1; and

FIG. 4 is a second flow chart showing the logic of the parking enforcement system of FIG. 1.

### DESCRIPTIONS OF THE PREFERRED EMBODIMENTS

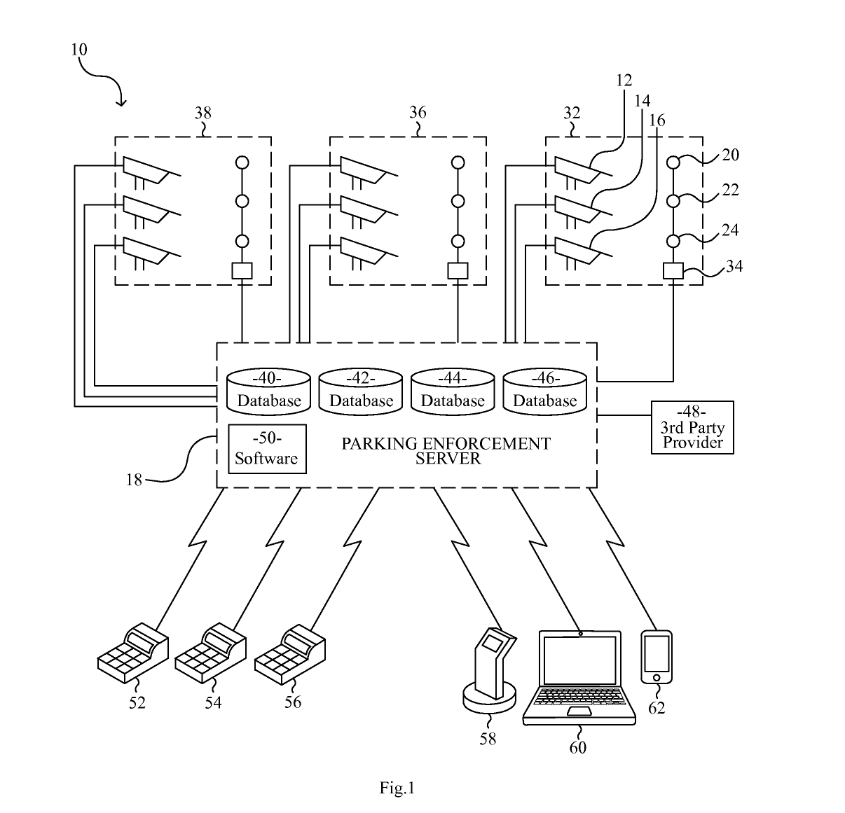

Referring to the drawings and first to FIG. 1 there is shown a parking enforcement system 10. The parking enforcement system 10 includes a plurality of cameras, for example cameras 12, 14, 16, which are positioned to capture a license plate image. The cameras may be positioned to capture a license plate image when a vehicle enters or exits a parking location. The cameras may also be positioned to capture a license plate image when a vehicle is in a parking spot or anywhere within a parking location. The cameras 12, 14 and 16 are each in communication with processor and, in this example, a parking enforcement server 18. The parking enforcement system 10 also includes a plurality of sensors, for example electromagnetic sensors 20, 22, and 24, which are positioned to sense the presence of a vehicle. The sensors may sense the presence of a vehicle when the vehicle enters or exits a parking location. The sensors may also be positioned to sense the presence of a vehicle in a parking spot or anywhere within a parking location.

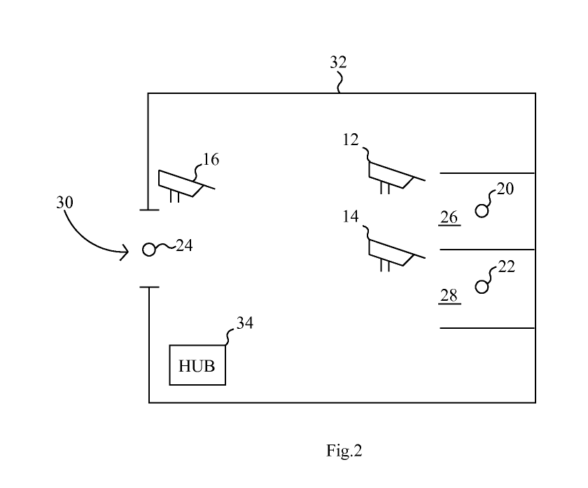

Exemplary positioning of the cameras and the sensors is best shown in FIG. 2. One of the cameras 16 is positioned near an entrance 30 of a parking location 32 to capture a license plate image when a vehicle enters or exits the parking location 32. A first one of the sensors 20 is positioned to sense when a vehicle is in the first parking spot 26 and a second one of the sensors 22 is positioned to sense when a vehicle is in the second parking spot 28. The camera 16 may be placed behind a management software firewall with each camera being uniquely identified by a keep-alive signal. This provides the ability to dynamically monitor and manage a multiple cameras in a multiple parking locations. The sensors 20 and 22 may be arranged in a mesh network. This allows communication between individual sensors and the transmission of a signal to a main hub 34 with minimal power consumption. The main hub 34, as best shown in FIG. 1, is in communication with the parking enforcement server 18.

The parking enforcement system 10 may include additional parking locations, for example parking locations 36 and 38, which also have cameras and sensors in communication with the parking enforcement server 18. There are databases, for example databases 40, 42, 44, and 46, on the parking enforcement server 18. The databases may store parking information or payment information or both. In this example, a first one of the databases 40 stores parking information received from the first parking location 32. A second one of the databases 42 stores parking information received from the second parking location 36. A third one of the databases 44 stores parking information received from the third parking location 38. Each of the first, second, and third databases 40, 42, and 44 may also receive payment information from a respective one of the parking locations 32, 36, and 38 or the third party provider 48 or both. A fourth one of the databases 46 stores payment information including a list of known license plate numbers which are each associated with a corresponding payment event. The parking enforcement system 10 is able to correlate license plate images from the parking locations with a payment event using license plate recognition software 50 which generates a license plate number from the license plate image.

The parking enforcement system 10 also includes processors in the form of remote terminals, for example portable remote terminal 52, 54, and 56, which are in communication with the parking enforcement server 18. In this example, the remote terminals and the parking enforcement server are in communication via the general packet radio service (GPRS). The parking enforcement server 18 may selectively transmit parking information or payment information or both to the terminals 52, 54, and 56 as required. For example, the parking enforcement server 18 may transmit parking information or payment information or both to the terminals 52, 54, and 56 when it is necessary to issue a citation. The parking information or payment information or both may then be used by a parking enforcement officer to issue a citation for unpaid parking events, i.e. a parking event that is not associated with a payment event. A user may communicate with the parking enforcement server 18 using a processor which may be, for example, a fixed payment terminal 58 in communication with the parking enforcement server via a LAN or WAN, a computer 60 in communication with the parking enforcement server via the Internet, or a smartphone 62 in communication with the parking enforcement server via the GPRS. The user would communicate with the parking enforcement server 18 to initiate a payment event for a present or future parking event. The user may also initiate a payment for a present or future parking event through the third party provider.

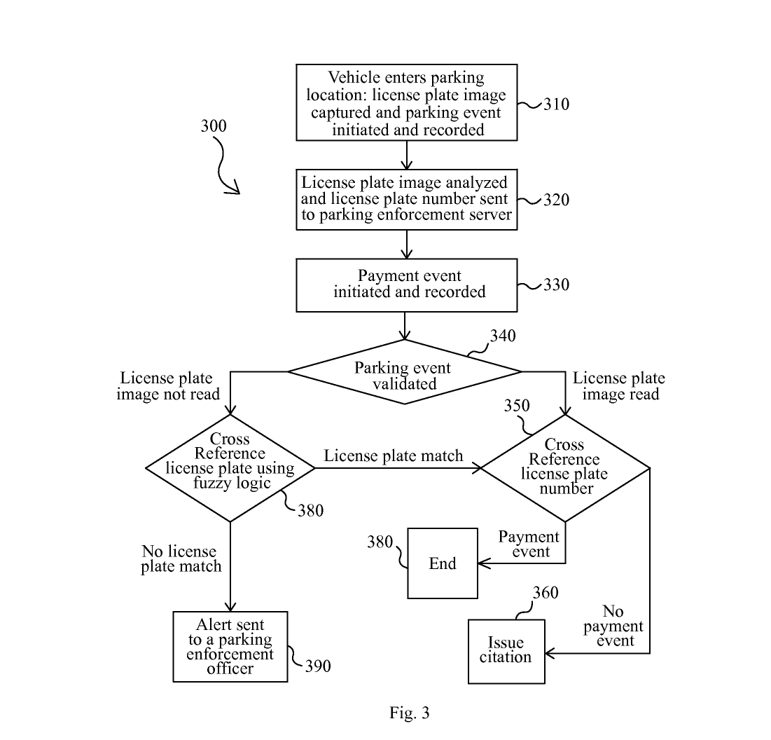

A logic 300 of the parking enforcement system disclosed herein is shown in FIG. 3. A parking event is recorded at step 310 when a vehicle enters into a parking location and a license plate image is captured by the license plate camera. The license plate image is then analyzed using license plate recognition software and sent to the parking enforcement server at step 320. The user is given a predetermined amount of time to initiate a payment event at step 330. The vehicle parks in a vacant parking location and a sensor may confirms the presence of the vehicle and validate the parking event at step 340. The payment event may result, for example, from payments made a user at pay station, by phone, through a smart phone application, through the Internet, or through the purchase of a permit or pass. The sensors may signal when the vehicle enters or exits the parking spot whereas the license plate camera will verify when the vehicle is in a parking location.

If the license plate image can be read then the license plate number is cross-referenced against known lists at step 350 to determine if a payment event is associated with the parking event. An alert will be sent to a terminal associated with the parking location at step 360 to advise a parking enforcement officer to issue a citation when a payment event is not associated with the parking event. Otherwise the parking enforcement system will associate the parking event with a payment at step 370. If the license plate image cannot be read then the partially or incorrectly read license plate number is cross-referenced against known lists using ‘fuzzy logic’ at step 380 to determine, with a high degree of certainty, if partially or incorrectly read license plate number is associated with a payment event. An alert will be sent to a terminal associated with the parking location at step 390 to advise a parking enforcement officer to issue a citation when parking event is not or cannot be associated with the payment event.

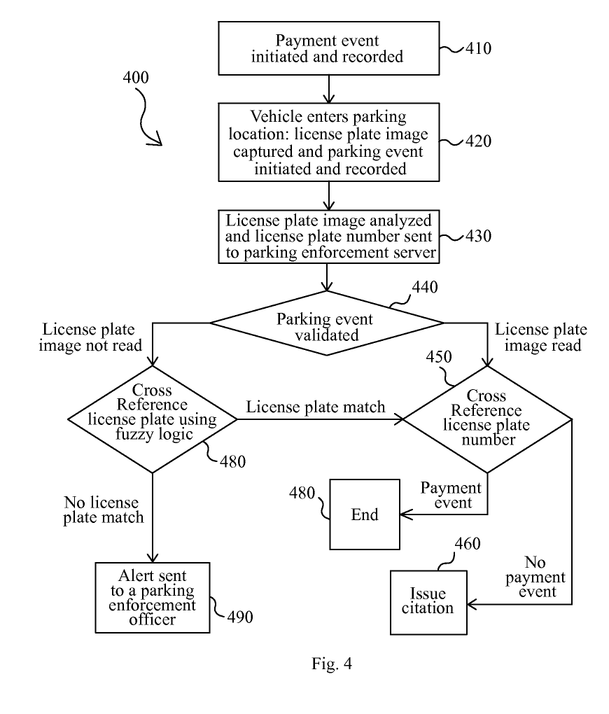

The logic 300 of the parking enforcement system shown in FIG. 3 is for situations in which a payment event is initiated for a present parking event. FIG. 4 shows a logic 400 of the parking enforcement system when a payment event is initiated for a future parking event. A user initiates a payment event for a future parking event at step 410. The parking event is recorded at step 410 when a vehicle enters into a parking location and a license plate image is captured by the license plate camera. The license plate image is analyzed using license plate recognition software and sent to the parking enforcement server at step 430. The vehicle parks in a vacant parking location and a sensor may confirms the presence of vehicle and validate the parking event at step 440.

If the license plate image can be read then the license plate number is cross-referenced against known lists at step 450 to determine if a payment event is associated with the parking event. An alert will be sent to a terminal associated with the parking location at step 460 to advise a parking enforcement officer to issue a citation when a payment event is not associated with the parking event. Otherwise the parking enforcement system will associate the parking event with a payment at step 470. If the license plate image cannot be read then the partially or incorrectly read license plate number is cross-referenced against known lists using ‘fuzzy logic’ at step 480 to determine, with a high degree of certainty, if partially or incorrectly read license plate number is associated with a payment event. An alert will be sent to a terminal associated with the parking location at step 490 to advise a parking enforcement officer to issue a citation when parking event is not or cannot be associated with the payment event.

In addition to alerting parking enforcement officers when there is no payment event for a parking event, the parking information and payment information stored on the parking enforcement server may be used to generate selective summary information for the parking enforcement officers. The summary information may be, for example, a list of license plate numbers associated with a payment event in a given parking location, a list of license plate numbers not associated with a payment event in a given parking location, or a list of paid or unpaid parking spots in a given parking location.

It will be understood by a person skilled in the art that many of the details provided above are by way of example only, and are not intended to limit the scope of the invention which is to be determined with reference to the following claims.

What is claimed is:

1. A parking enforcement system comprising:
a camera capturing a license plate image at a parking location to record a parking event;
a server including a database storing a list of known license plate numbers that are each associated with a payment event; and
a network allowing the camera to communicate with the server, wherein license plate recognition software is used to analyze the license plate image to generate a read license plate number and the read license plate number is cross-referenced with the list of known license plate numbers to determine if the read license plate number is associated with a payment event.

2. The parking enforcement system as claimed in claim 1 wherein the license plate recognition software uses fuzzy logic to generate the read license plate number.

3. The parking enforcement system as claimed in claim 1 further including a processor in communication with the server to allow a user to communicate with the server.

4. The parking enforcement system as claimed in claim 1 further including a sensor to sense and validate the parking event at the parking location.

5. The parking enforcement system as claimed in claim 4 wherein the sensor is one of a plurality of sensors arranged in a mesh network.

6. The parking enforcement system as claimed in claim 4 further including a hub that receives a signal from the sensor when the sensor senses the parking event.

7. The parking enforcement system as claimed in claim 1 further including a database which stores parking information and payment information received from the parking location.

8. The parking enforcement system as claimed in claim 4 further including remote terminals in communication with server, wherein the parking information or the payment or both may be selectively transmitted from the server to the remote terminals.

9. The parking enforcement system as claimed in claim 5 wherein the remote terminals are in communication with the processor via a general packet radio service.

10. A method of parking enforcement comprising:
capturing a license plate image with a camera at a parking location to record a parking event;
analyzing the license plate image with license plate recognition software to generate a read license plate number;
associating the read license plate number with the parking event;
cross-referencing the read license plate number with a list of known license plates that are each associated with a payment event to determine if the read license plate number is associated with a said payment event.

11. The method of parking enforcement as claimed in claim 10 wherein analyzing the license plate image with the license plate recognition software includes analyzing the license plate image using fuzzy logic.

12. The method of parking enforcement as claimed in claim 10 further including selectively communicating information to a remote terminal when:
the read license plate number is associated with the parking event; and
the read license plate number is not associated with a said payment event.

13. The method of parking enforcement as claimed in claim 12 further including communicating information to the remote terminal via a general packet radio service.

14. The method of parking enforcement as claimed in claim 12 further including using a sensor to sense a vehicle in the parking location and thereby validate the parking event.

15. The method of parking enforcement as claimed in claim 14 wherein information is only communicated to the remote terminal if the parking event has been validated.

16. The method of parking enforcement as claimed in claim 12 further including issuing a citation against the read licence plate number if the read license plate is not associated with a payment event.

17. The method of parking enforcement as claimed in claim 12 further including selectively communicating information to the remote terminal if the license plate recognition software cannot generate a said read license plate number.
